(19) United States
(12) Patent Application Publication
(10) Pub. No.: US 2003/0136788 A1
(43) Pub. Date: Jul. 24, 2003

(54) Fuel tank and method of making same

(76) Inventor: Albert Marion Beaty, Monticello, GA (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/056,764

(22) Filed: Jan. 24, 2002

(51) Int. Cl. B60P 3/00; B62D 33/00; B65D 88/12

(52) U.S. Cl. 220/562

(57) ABSTRACT

A heat and effusion resistant fuel tank (34) and method of fabricating it wherein granules (12) of a thermoplastic are melted to a viscous state and amorphous silica in a powder state (14) is added and mixed into a compound. The compound is pelletized (22) and later processed through an injection molding machine (26) to form a fuel tank (34) in a mold (32).

### BACKGROUND OF THE INVENTION

1. Field of the Invention

This invention relates to fuel tanks made of a thermoplastic material.

2. Description of the Prior Art

The well known steel fuel tanks present problems with corrosion resistance to the many fuels used in automotive vehicles. It is also difficult to fabricate a steel fuel tank into a complex form desired by designers to efficiently utilize space in a vehicle.

Consequently, there has been a significant development in the fabrication of fuel tanks from plastic materials. Examples of such are disclosed in U.S. Pat. No. 5,344,038 to Freeman et al, U.S. Pat. No. 5,384,172 to Takado et al and U.S. Pat. No. 6,305,568 to Suzuki et al.

Nonetheless, there remains a need for an improved fuel tank to increase the resistance to heat (fire) and to the effusion of hydrocarbons.

### SUMMARY OF THE INVENTION AND ADVANTAGES

The subject invention provides a method of fabricating a heat and effusion resistant fuel tank with a material that combines a thermoplastic and amorphous silica to form a compound, heating the compound, and forming a hollow fuel tank.

### BRIEF DESCRIPTION OF THE DRAWINGS

Other advantages of the present invention will be readily appreciated as the same becomes better understood by reference to the following detailed description when considered in connection with the accompanying drawings wherein

FIG. 1 is a schematic showing the method of fabricating a component in accordance with the subject invention.

### DETAILED DESCRIPTION OF THE PREFERRED EMBODIMENT

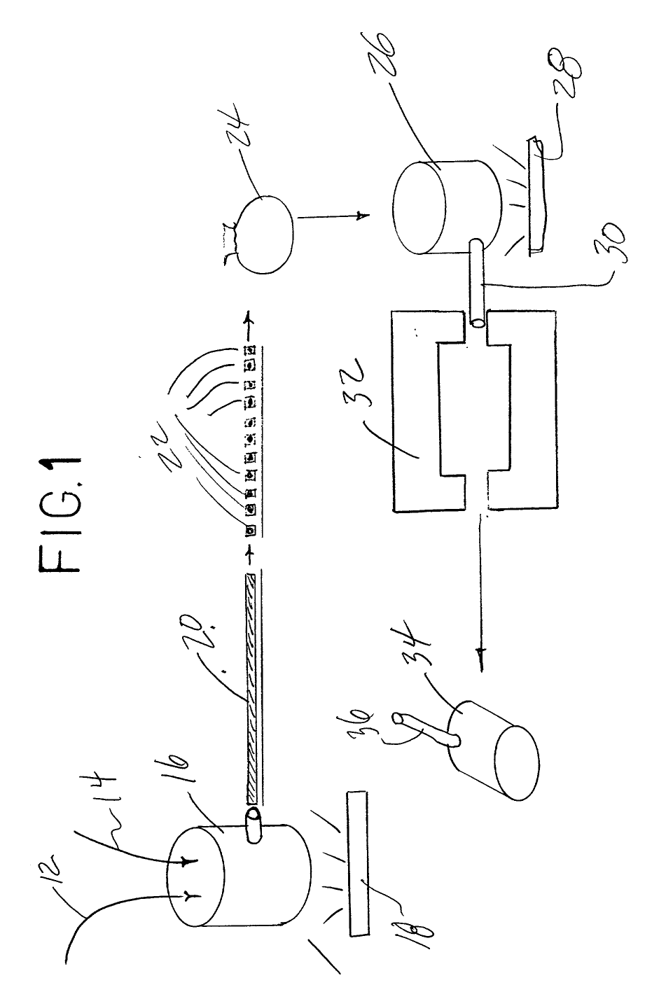

Referring to FIG. 1, a method of fabricating a heat and effusion resistant fuel tank is shown schematically.

The first step is the compounding or combining of a thermoplastic material 12, such as a high-density polyethylene (HDPE), with amorphous silica 14 to form a compound. The thermoplastic 12 is in the form of granules and the amorphous silica 14 is in the form of a powder. Rice Chemistry Corporation sells the amorphous silica 14 under the trademark RICE/SIL-100 in a “powder-like form. The amorphous silica may be combined with the thermoplastic to form the compound by any one of several different methods including “filling” the thermoplastic with amorphous silica during the fabrication of the monomer or polymer resin or combining the amorphous silica with the resin after its manufacture. In the latter case the thermoplastic in its commonly supplied pelletized form would be heated until it reached a viscous state and the amorphous silica would be combined (mixed) with the viscous thermoplastic to form a viscous compound. This mixing process could take place in the “barrel” of a molding machine and the compound injected directly into a mold for the manufacture of a fuel tank or the mixing process could take place in another mixing device and the compound would be further processed to a useable form. In the latter case the compound may be processed through an extruder, solidified and pelletized for example. The compounding may be accomplished in any suitable mixing apparatus such as an extruder 16. The compound is heated into a viscous state in the extruder 16. Actually, the thermoplastic 12 is heated by a heater 18 to a viscous state and the powered amorphous silica 14 is added to form a heated and viscous compound which is then extruded from the extruder 16 to form a strand 20. As is well known, the strand is cooled into a solid that is subsequently chopped or cut into pellets 22.

At some later time and perhaps at another location, the pellets 22 of the compound are poured from a container 24 into a molding machine 26. The pellets 22 are heated in the molding machine 26, as by a heater 28, into a viscous paste. The viscous paste of the compound is injected through an injector 30 into a mold 32 for forming a hollow fuel tank 34. The fuel tank is formed with a filler neck defining an opening 36, the neck can be of any length for filling the tank with fuel. The filler neck 36 could be very short, and even a simple opening, and affixed to a longer entry tube (not shown).

The method may be further defined as heating the compound to a temperature of between 200 and 500 degrees Fahrenheit with the thermoplastic being heated to a viscous condition before adding the amorphous silica powder.

In one instance, the amorphous silica was 30% by volume of the compound.

Accordingly, the subject invention provides a heat and effusion resistant fuel tank comprising a hollow body having a filler neck or opening for receiving fuel and consisting of a homogeneous thermoplastic filled with amorphous silica. The amorphous silica may be in the range of 10% to 50% of the fuel tank.

Obviously, many modifications and variations of the present invention are possible in light of the above teachings. The invention may be practiced otherwise than as specifically described within the scope of the appended claims.

What is claimed is:

1. A method of fabricating a heat and effusion resistant fuel tank comprising the steps of;
combining a thermoplastic and amorphous silica into a compound,
heating the compound, and
forming a hollow fuel tank with a filler opening with the compound.

2. A method as set forth in claim 1 wherein the combining is further defined as mixing granules of the thermoplastic with a powder of amorphous silica.

3. A method as set forth in claim 2 including heating the compound to a viscous form.

4. A method as set forth in claim 3 further defined as heating the compound to a temperature of between 200 and 500 degrees Fahrenheit.

5. A method as set forth in claim 4 further defined as heating the thermoplastic to a viscous condition and then adding the amorphous silica powder.

6. A method as set forth in claim 5 further defined as compounding the thermoplastic and amorphous silica in an extruder.

7. A method as set forth in claim 6 including extruding the compound into a strand and dividing the strand into pellets of the homogenous compound.

8. A method as set forth in claim 7 including heating the pellets of the compound into a viscous condition and molding the fuel tank.

9. A method as set forth in claim 8 wherein the amorphous silica is in the range of 10% to 30% by volume of the compound.

10. A method of fabricating a heat and effusion resistant fuel tank comprising the steps of;
heating and mixing pellets of a thermoplastic with a powder of amorphous silica into a viscous compound, and
forming a hollow fuel tank with a filler opening with the compound.

11. A method of fabricating an automotive component comprising the steps of;
combining a thermoplastic and amorphous silica into a compound,
heating the compound, and
forming a component with the compound.

12. A method of fabricating a heat and effusion resistant fuel tank comprising the steps of;
adding granules of a thermoplastic into an extruder,
heating the granules of the thermoplastic in the extruder to reach a viscous condition,
adding an amorphous silica powder into the viscous thermoplastic to form a homogenous compound,
extruding the compound through the extruder to form a strand of the compound, cooling the strand into a solid,
chopping the strand into pellets;
pouring the pellets into a barrel of a molding machine;
heating the barrel of the molding machine to turn the pellets into a viscous paste; and
injecting the viscous paste into a mold to form a hollow fuel tank

13. A heat and effusion resistant fuel tank comprising;
a hollow body,
a filler opening for receiving fuel,
said body and said neck consisting of a homogeneous thermoplastic filled with amorphous silica.

14. A heat and effusion resistant automotive component comprising of a homogeneous thermoplastic filled with amorphous silica.
